(19) United States
(12) Patent Application Publication
(10) Pub. No.: US 2026/0185665 A1
(43) Pub. Date: Jul. 2, 2026

(54) PROCESS AND SYSTEM WITH A LIQUID HYDROGEN CENTRIFUGAL PUMP

(71) Applicant: Linde GmbH, Pullach (DE)

(72) Inventors: Alexander ALEKSEEV, Pullach (DE); Christoph BALLHAUSEN, Pullach (DE); Christian WOLF, Pullach (DE); Chengyuan WU, Pullach (DE)

(21) Appl. No.: 19/183,395

(22) Filed: Apr. 18, 2025

(30) Foreign Application Priority Data
Apr. 23, 2024 (EP) 24020126.9

(51) Int. Cl. F17C 7/02; F17C 5/02

(52) U.S. Cl. CPC F17C 7/02; F17C 5/02; F17C 2205/0388; F17C 2221/012; F17C 2223/0169; F17C 2225/0169; F17C 2225/033; F17C 2227/0142

(57) ABSTRACT

A method and a system for transferring liquid hydrogen from a first vessel to a second vessel by using a liquid hydrogen centrifugal pump, wherein the pressure p₄ in the second vessel is higher than the pressure p₁ in the first vessel, wherein a first subcooling device is used upstream of the centrifugal pump, wherein a second subcooling device is used downstream of the centrifugal pump and wherein the first subcooling device, the second subcooling device and the centrifugal pump are located in the same cryostat.

### CROSS-REFERENCE TO RELATED APPLICATIONS

This application claims priority pursuant to 35 U.S.C. 119(a) to European Patent Application No. 24020126.9, filed Apr. 23, 2024, which application is incorporated herein by reference in its entirety.

### FIELD OF THE INVENTION

The present invention relates to a method and a system for transferring liquid hydrogen from a first vessel to a second vessel by using a liquid hydrogen centrifugal pump, wherein the pressure in the second vessel is higher than the pressure in the first vessel and wherein a first subcooling device is used upstream of the centrifugal pump.

### BACKGROUND

The transfer or loading bulk amounts of liquid gases or cryogens, e.g. liquid nitrogen, liquid natural gas or liquid hydrogen from one vessel to another vessel is a widely known process. It has to be considered, that in a vessel, for the storage of liquid gases, there is always a liquid phase and a gas phase, because part of the liquid is evaporated (ullage).

During a first step, at the beginning of the loading procedure the second vessel, which is the receiving vessel, is connected by means of a pipeline (1^{st} pipeline) to a first vessel, which is the donor vessel, via a coupling. The pipeline can be executed as rigid pipeline, flexible hoses or combination of both. The coupling procedure may consider several purging steps as well as checks for leakage, pressure stability or purity of the to be transferred liquid gas.

The pipeline (1^{st} pipeline) is usually connecting the liquid phase in the first vessel with the gas phase in the second vessel. It is also possible that the liquid phase in the first vessel is connected with the liquid phase in the second vessel.

The gaseous phase of the second vessel is connected to a sink by means of a pipeline (3^{rd} pipeline) through a valve. The role of a sink is often executed by a flare, a compressor, a storage vessel or other means to store or waste the excess gas, which is in gaseous phase. This is necessary to compensate pressure rises in the second vessel if it is filled with liquid gas or if more gas is evaporated by heat intake.

In a second step a pressure difference between both vessels is created. Basically, the pressure in the first vessel must be higher than the pressure in the second vessel. Such a pressure difference is usually created by either reducing the pressure in the second vessel or increasing the pressure in the first vessel. Reducing the pressure in the second vessel can be done by emptying the vessel or by using the hydrostatic differences if the second vessel is placed lower than the first vessel. Alternatively, the pressure in the first vessel can be increased by an integrated pressure control system or an external pressurized gas source. In a state of the art integrated pressure control system typically heat is used to vaporize at least a portion of the liquid gas and potentially superheat the newly formed gas. Returning this gas with the resulting higher enthalpy back into the vessel, leads to a pressure increase in the vessel. By controlling the heat and/or the vaporized portion of liquid gas the pressure can be controlled.

A pressure increase in the first vessel can be also realized by using a heater, preferably an electrical heater, to evaporate parts of the liquid phase. It is also possible to use methods to increase or decrease the pressure in parallel.

After setting the pressure difference the transfer of the liquid gas can be started. During the filling the pressure in each vessel can be maintained by the above describe methods. Due to the pressure difference in the first vessel and the second vessel the liquid gas is expanded from p₁ to p₄. Due to this expansion some flash gas is generated. Together with gas, which is created by heat intake, this gas phase is usually called boil-off gas. This gas phase, together with the gas which needs to be removed due to the increase of the liquid gas filling level is removed by a pipeline (3^{rd} pipeline) towards the sink.

At the end of the filling process the vessels are disconnected. If required cold parts can be warmed up and pipelines can be purged.

The first vessel needs to be refilled itself. This can be realized if the first vessel is connected to a liquid feed pipeline or a gas pipeline. If necessary, a feed device, e.g., a liquefier, another storage tank or another source of the liquid hydrogen or gaseous hydrogen can be connected to the first vessel to support its filing.

One example where such a system is used is the use of a liquid hydrogen trailer. If the trailer is filled itself, it acts as second vessel. If the trailer is transported to a consumer, it acts as first vessel. Therefore, all described vessel need to be equipped with a pressure build-up unit. Preferably such a trailer has a rated pressure of 13 bar, which corresponds to the critical pressure of hydrogen. So, the trailer can operate as first or second vessel in a pressure range from about 1 to about 13 bar.

Common engineering knowledge suggests as well to fill a vessel by using a pump. In terms of liquid hydrogen this option is not yet common and used, but it is known for other cryogen fluids.

In such a process the first vessel is connected to an inlet of a liquid gas pump, e.g., a liquid hydrogen pump. The outlet of the liquid gas pump is connected to a second vessel. The connection uses preferably a coupling. The connecting pipelines between the first and the second vessel can be executed as a rigid pipeline, flexible hoses or a combination of both. If a coupling is used, the coupling procedure may include some purging steps.

In this process the liquid gas pump creates a pressure difference, which is required for the liquid transport. However, the pressure in the second vessel can be either higher or lower than the pressure in the first vessel.

If the pressure of the second vessel is higher than the pressure of the first vessel, the gaseous phases of both vessels can be connected by an additional pipeline. Therefore at least a portion of the boil-off gas in the second vessel can be recovered in the first vessel. The remaining boil-off gas can be transferred to a sink. The advantage of this process is, that first at least a part of the hydrogen gas is recycled within the system and the pressure in the first vessel can stay reduced, whereas less efforts are necessary to increase the pressure, e.g., by evaporating part of the liquid gas by the above described methods.

A suitable liquid gas pump, which can be used for liquid hydrogen, could be a reciprocating pump or a centrifugal pump.

Centrifugal pumps are limited in terms of the pressure differences they can create, so the use of multistage centrifugal pumps could be necessary.

Challenging for liquid gas pumps and especially for cryogenic liquids are the low temperature levels. Additionally for liquid hydrogen, with special physical properties, a complex pump design is required. Liquid hydrogen has a lower gravimetric density compared to other cryogenic liquids, which requires either a higher impeller speed or more stages to generate a sufficient pressure difference. Pumping liquid hydrogen has still a high risk for cavitation and damage of the pump.

To avoid the heat intake from the pump into the liquid gases, a complex thermal insulation system is necessary. Additionally, the materials used for the pump need to withstand the low temperature level of the cryogenic fluids. Especially important is the selection of the materials for a submerged pump. This means, the complete pump is submerged in the liquid gas, e.g., in the liquid hydrogen.

A further possibility to avoid a damage of the pump due to cavitation, is the implementation of a pump inducer to increase the static pressure of the liquid gas before the main impellers of the pump are reached.

Additional effort if liquid hydrogen is pumped, compared to cryogenic inert gases, is needed to comply with legal safety especially in terms of explosion protection.

The low viscosity of liquid hydrogen, especially combined with the low temperature level, brings the necessity of a high effort for sealings.

As well it is challenging to build up a pressure increase by using centrifugal pumps, because of the low density of liquid hydrogen. Many pump stages (series of impellers) are needed to build up the pressure increase. This induces vibrations in the pump due to imbalances, which does not allow very high rotation speed.

During the last years a lot of technical solutions have been published to improve liquid hydrogen centrifugal pumps. But the challenge is not only the pump itself, also the overall pumping process needs to be considered.

Furthermore, different proposals have been made to adjust the thermodynamic properties of liquid hydrogen at a pump discharge side.

But still the process of transfer liquid hydrogen is not efficient, and hydrogen is lost.

### SUMMARY OF THE INVENTION

Therefore, it is the object of the present invention to accelerate the transfer of liquid hydrogen from a first vessel to a second vessel while minimizing the loss of liquid hydrogen by using a centrifugal pump.

This is realized by using a method and a system described in the independent claims, supported by the dependent claims.

According to the present invention there is method provided for transferring liquid hydrogen from a first vessel to a second vessel by using a liquid hydrogen centrifugal pump, wherein the pressure (p4¬) in the second vessel is higher than the pressure (p1) in the first vessel, wherein a first subcooling device is used upstream of the centrifugal pump, characterized in that a second subcooling device is used downstream of the centrifugal pump and wherein the first subcooling device, the second subcooling device and the centrifugal pump are located in the same cryostat.

The advantage of using a subcooling device upstream of the centrifugal pump is to ensure sufficient net positive suction head (NPSH_{A}) value and therefore minimize the risk of pump damage due to cavitation.

The net positive suction head (NPSH_{A}) value is usually defined as the absolute pressure head minus the vapor pressure of the liquid on the suction side of the pump.

In a preferred embodiment the centrifugal pump is submerged in a pump sump.

Preferably the pressure p₄ is lower than the pressure p₁+3bar (p₄<(p₁+3 bar)).

In another preferred embodiment the efficiency of the centrifugal pump is greater than 30%.

The efficiency is usually defined by the increase of hydraulic power of the fluid between the suction and the discharge side of the pump, divided by the electrical power input.

In another preferred embodiment with a valve, installed downstream of the centrifugal pump, the amount of liquid hydrogen flowing through the second subcooling device and the amount bypassing it is adjusted, wherein both streams coming from the second subcooling device and from the outlet of valve are mixed again to reach the required thermodynamic state.

The system for transferring liquid hydrogen from a first vessel to a second vessel, with a liquid hydrogen centrifugal pump, wherein a first subcooling device is positioned upstream of the centrifugal pump, in such a way that a second subcooling device is connected to the system downstream of the centrifugal pump and wherein the first subcooling device, the second subcooling device and the centrifugal pump are located in the same cryostat.

In a preferred embodiment of the system there is a valve installed downstream of the centrifugal pump, which is able to adjust the amount of liquid hydrogen flowing through the second subcooling device and the amount bypassing it, wherein both streams coming from the second subcooling device and from the outlet of valve V6 are mixed again to reach the required thermodynamic state.

If the pressure difference, created by a centrifugal pump, is high, the power requirements for the pump are high and at least some part of the power is converted in heat, which causes an increase of the temperature of liquid hydrogen and can occur evaporation.

If the pressure difference, created by a centrifugal pump, is low, the process to transfer liquid hydrogen form one vessel to the other takes much time.

### BRIEF DESCRIPTION OF THE DRAWINGS

In the following two embodiments are described schematically. Only the parts which are relevant are named.

FIG. 1: schematically shows prior art; and,

FIG. 2: schematically shows one example of an embodiment.

### DETAILED DESCRIPTION OF THE INVENTION

In the following different embodiments are described schematically with a focus on the relevant parts. Same reference signs indicate same or essentially the same units. It is appreciated that a person skilled in the art may combine or add certain components like valves, lines, etc.

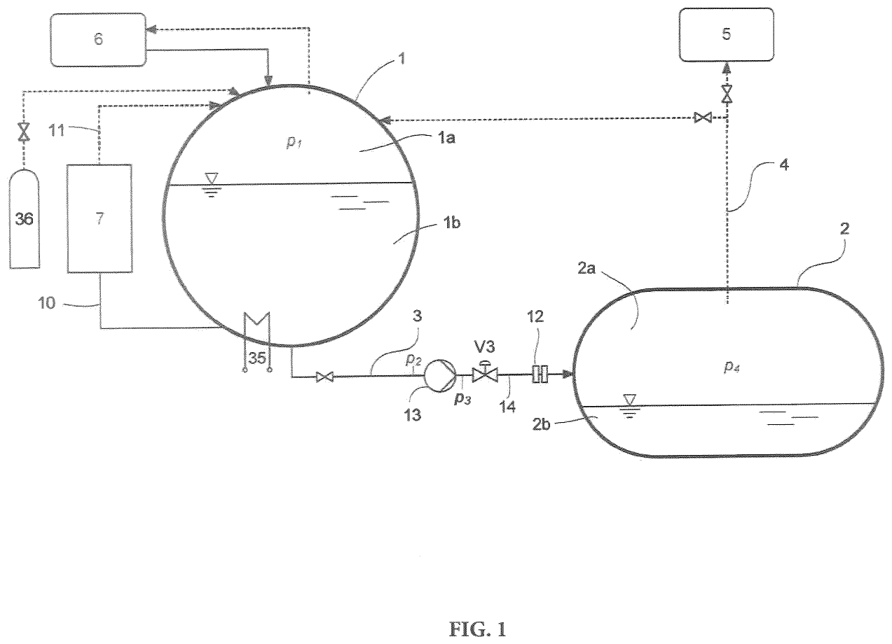

FIG. 1 shows schematically a set up known from prior art. It shows a first vessel 1 for liquid hydrogen. This first vessel 1 can also be described as donor vessel. If liquid hydrogen (LH₂) is in the vessel it forms a liquid phase 1b with the ullage above consisting of a gaseous hydrogen 1a. The first vessel 1 is connected to a second vessel 2. This second vessel 2 can also be called receiver vessel. If LH₂ is in the second vessel it also forms a liquid phase 2b and there is also a gas phase 2a consisting of gaseous hydrogen.

The first vessel 1 is connected by pipeline 3, 14 with the second vessel 2. This pipeline contains valves V3 and a pump 13, which is in this example a centrifugal pump.

The pressure in the first vessel 1 is p₁, the pressure in the second vessel 2 is p₄, the pressure in pipeline 3, 14 upstream of the pump 13 is p₂ and downstream of the pump 13 the pressure is p₃. The pipeline 3, 14 between the two vessels can be easily connected and disconnected by using a coupling 12.

Gas from the gas phase 2a in the second vessel is guided to a sink 5 by using pipeline 4. Alternatively, the gas phase can be recovered and guided into the first vessel 1, preferably into the gas phase 1a.

In the presented example the first vessel 1 is connected to at a feed device 6. The feed device may be another storage tank, a hydrogen liquefier, or another source of liquid hydrogen and sink of gaseous hydrogen.

The present example also contains a pressure control system 7 which is connected to the donor vessel via a pressure control system inlet line 10 and a pressure control system outlet line 11. This pressure control system 7 is used to control the pressure in the first vessel 1.

Pressurization of the first vessel 1 can be achieved by an electric heater 35 or an external pressurized gas source 36, which is connected to the vessel via pipeline with the first vessel. FIG. 1 shows both possibilities, but it can be that only one system is installed.

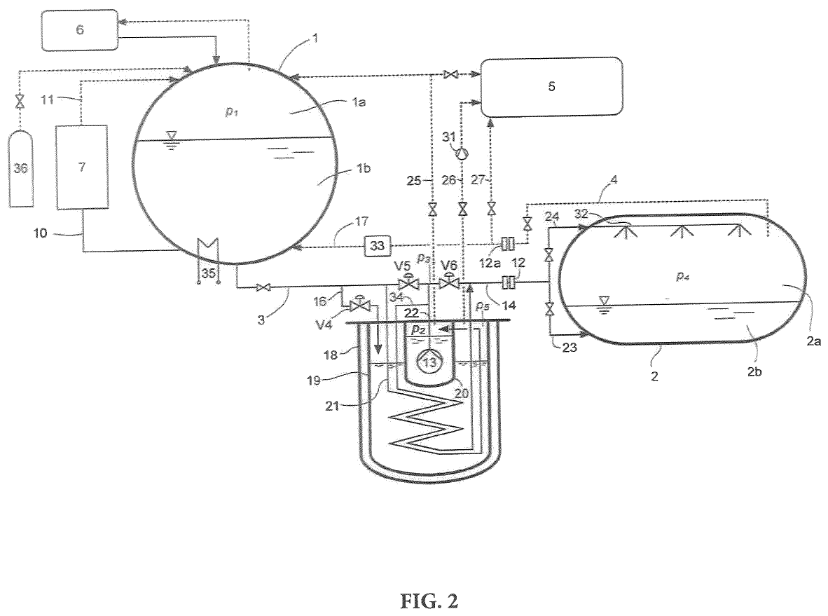

FIG. 2 shows schematically one embodiment of the invention. Same reference signs indicate same or essentially the same units as in FIG. 1.

In this embodiment in pipeline 3, connecting the first vessel 1 and the second vessel 2, a first subcooling device 21 is used upstream of the centrifugal pump 13 and a second subcooling device 34 is used downstream of the centrifugal pump 13 and the first subcooling device 21, the second subcooling device 34 and the centrifugal pump 13 are located in the same subcooling cryostat 18.

The subcooling devices can also be described as subcooling conduit.

Pipeline 16 connects the cryostat 18 via an expansion valve V4. A part of the liquid hydrogen, which should be transferred to the second vessel 2, is expanded with the expansion valve V4 and guided to the cryostat 18. Due to the expansion, the fluid gets biphasic and resulting liquid and gas in the subcooling cryostat 18 is present at a lower pressure p₅ and temperature level than in the pump sump 20 of the centrifugal pump 13, where pressure p₂ is measured. (p5<p2).

The subcooling cryostat 18 or only call cryostat can be designed doubled-walled, with a second wall 19. Between the outer wall and the second wall 19, there is a thermal insulation.

The liquid hydrogen in the first subcooling device 21 is subcooled due to the conduit being in contact with the cold liquid in the subcooling cryostat 18 before entering the pump sump 20 of the centrifugal pump 13.

The pump sump 20 is integrated in the subcooling cryostat 18, therefore no separate cryostat for the pump sump is needed. In the pump sump 20 there is subcooled liquid present, coming from the first subcooling device 21 and above the liquid there is an ullage consisting of gas with the pressure p2. The centrifugal pump 13 located in the pump sump 20 sucks in subcooled liquid and discharges it at the pressure p₃ into the discharge pipeline 22. The discharge pipeline 22 splits into two branches. The first branch is connected to valve V6. The second branch is connected to the second subcooling device 34 which is also located in the subcooling cryostat 18, therefore no additional cryostat is needed. The liquid hydrogen in the second subcooling device 34 is subcooled due to the conduit being in contact with the cold liquid in the subcooling cryostat 18 before getting mixed with the liquid hydrogen coming from the outlet of valve V6. This mixture is guided in pipeline 14 to the coupling 12 and can be directed into the second vessel either in the liquid phase 2b by pipeline 23 or in the gas phase 2a by pipeline 24.

By adjusting valve V6 the share of discharged liquid hydrogen coming from the centrifugal pump 13 that is streaming through the second subcooling device 34 can be controlled. In this way, by adjusting valve V6, the thermodynamic state of the liquid hydrogen in pipeline 14 leading to the second vessel 2 can be adjusted. The pump discharge pipeline 22 is connected via a bypass valve V5 to the pipeline 3.

In FIG. 2 it is optionally shown that the liquid hydrogen can be injected into the gas phase 2a of the second vessel 2 via top fill line 24 and potentially a spray bar or nozzle 32.

The ullage gas of the pump sump 20 passes the gas pipeline 25. From there the gas can be returned to the first vessel 1 or alternatively to the sink 5. The role of the sink 5 can be executed by a flare, a compressor, a storage vessel, other devices or simply a safe location. Gas from the gas phase 2a from the second vessel 2 is recovered via pipeline 4 optionally via a second coupling 12a and via a pipeline to the first vessel 1 and optionally injected into the gas phase 1a or the liquid phase 1b. Alternatively, parts of the gas stream or the complete gas stream coming from the gas phase 2a from the second vessel 2 can be channeled via pipeline 27 to the sink 5.

The ullage of the subcooling cryostat 18 is connected to the sink 5 via pipeline 26. Optionally, a vacuum pump 31 can be used to decrease the pressure p₅ and the temperature level in the subcooling cryostat 18 further.

A device for removal of contaminations 33 for the returned cold gas in pipeline can be introduced and is shown in FIG. 2 optionally. It can be based on adsorption or membrane principle, for mechanical contaminations a simple mechanical filtering device is the preferred option. These units (adsorber, membrane mechanical filter) can be used alone as well as in every possible combination.

Corresponding to common engineering knowledge, check valves are used in gas and liquid pipelines, near vessels, cryostats, and other devices. Corresponding to the common engineering knowledge, safety valves are used in vessels and in gas and liquid pipelines as required. Corresponding to the common engineering knowledge a control unit can be used to control the valves, pumps, and other devices.

A centrifugal pump 13 provides a high flow rate, which makes the proposed LH2 transfer process a rapid procedure. The LH2 from the first vessel 1 is channeled to the pump sump 20 via the first subcooling device 21. Due to the LH2 being subcooled in the first subcooling device 21 before entering the pump sump 20 and the suction side of the pump 13, the NPSHA value is increased and therefore the risk of damage due to cavitation in the pump is minimized.

Due to friction losses in the pipelines, the pressure of the LH2 decreases, so that p₂<p₁. The pressure control system 7, or an optional electric heater 35 or an optional external pressurized gas source 36, can be used to adjust pressure p₁. As a result, the pressure p₂ changes accordingly. In this way, the NPSHA value can be adjusted additionally.

The centrifugal pump 13 increases the pressure of the LH2 from p₂ to p₃. Due to the sufficient efficiency of the pump (>30%), the LH2 is thermodynamically in the subcooled region at p₃ at the discharge side of the pump.

The thermodynamic state of the discharged LH2 streaming to the receiver vessel can be controlled by adjusting the valve V6 and therefore adjusting the amount of LH2 flowing through the second subcooling device 34 and the amount bypassing it. Both streams coming from the second subcooling device 34 and from the outlet of valve V6 are mixed again in pipeline 14 and reach the required thermodynamic state. Optionally, the bypass valve V5 can be used to bypass the pump 13.

The cryostat 18 is filled with biphasic, expanded fluid, coming from the expansion pipeline 16 and the expansion valve V4. Because of the expansion, the pressure p₅ is lower than p₁, p₂ and p₃. Due to the low pressure p₅, the liquid part of the expanded fluid in the subcooling cryostat 18 has a lower temperature than the liquid in the first subcooling device 21 or in the second subcooling device 34, and therefore they can be subcooled.

Optionally, the pressure p₅ and the corresponding temperature in the subcooling cryostat 18 can be decreased even further by using a vacuum pump 31.

Optionally, the pressure p₄ in the receiver vessel can be controlled by adjusting between top fill 24 and bottom fill 23, or a combination of both.

Optionally, a coupling 12 can be used to connect or disconnect the pipelines 14 and 17, which makes it possible that one of the vessels 1 or 2 or both are mobile vessels, for example road tankers.

The LH2 is channeled to the second vessel 2. Due to friction losses in the pipeline 14, the pressure of the LH2 decreases, so that p₄<p₃. Due to the subcooled state of the incoming LH2, parts of the H2-gas in the second vessel 2 can be re-condensed to liquid form. In this way, a) LH2 mass is gained in the receiver vessel; and b) the amount of vented H2 gas (in order to keep p₄ stationary) can be reduced. Possibly, at least for a part of the filling process, no-vent fill can be reached.

Since the pressure in the second vessel 2 p₄ can be higher than the pressure in the first vessel p₁, vented gas can be partly recovered over pipeline 4 and pipeline 17 from the second vessel 2 back to the first vessel 1. In this way, the losses of vented H2-gas over pipeline 27 are reduced and the amount of LH2 potentially vaporized in the pressure control system 7 of the first vessel 1, or the required pressurization of an optional electric heater 35 or an optional external pressurized gas source 36, can be reduced or even can be excluded or used for redundancy.

With such an embodiment and method to regulate the pressure, the loss of liquid hydrogen can be reduced by 10%, because vaporization is avoided and if there is gas, it can be re-condensed.

Cold gas from the second vessel can be recovered directly to the first vessel which has the following advantages compared to prior art. Less gas has to be vented, (e.g., through pipeline 27) or handled afterwards the sink (5).

In the pressure control system less liquid has to be vaporized in order to hold the pressure in the first vessel.

Not only the hydrogen itself, but also the cryogenic cold of the gas from the second vessel can be recovered.

This results in higher cost efficiency.

1. A method for transferring liquid hydrogen from a first vessel to a second vessel by using a liquid hydrogen centrifugal pump, wherein the pressure p₄ in the second vessel is higher than the pressure p₁ in the first vessel, wherein a first subcooling device is used upstream of the centrifugal pump, wherein a second subcooling device is used downstream of the centrifugal pump and wherein the first subcooling device, the second subcooling device and the centrifugal pump are located in the same cryostat.

2. The method according to claim 1, whereas the centrifugal pump is submerged in a pump sump.

3. The method according to claim 1, whereas the pressure p₄ is lower than the pressure p₁+3 bar.

4. The method according to claim 1, whereas the efficiency of the centrifugal pump is greater than 30%.

5. The method according to claim 1, whereas with a valve installed downstream of the centrifugal pump, the amount of liquid hydrogen flowing through the second subcooling device and the amount bypassing it is adjusted, wherein both streams coming from the second subcooling device and from the outlet of valve are mixed again to reach the required thermodynamic state.

6. A system for transferring liquid hydrogen from a first vessel to a second vessel, with a liquid hydrogen centrifugal pump, wherein a first subcooling device is positioned upstream of the centrifugal pump, wherein a second subcooling device is connected to the system downstream of the centrifugal pump and wherein the first subcooling device, the second subcooling device and the centrifugal pump are located in the same cryostat.

7. A system according to claim 6, wherein there is a valve installed downstream of the centrifugal pump, which is able to adjust the amount of liquid hydrogen flowing through the second subcooling device and the amount bypassing it, wherein both streams coming from the second subcooling device and from the outlet of valve are mixed again to reach the required thermodynamic state.
